(19) United States
(12) Patent Application Publication
(10) Pub. No.: US 2016/0162644 A1
(43) Pub. Date: Jun. 9, 2016

(54) STANDARD OF CARE PROCESS SYSTEM

(71) Applicant: Gloria Bindelglass, Easton, CT (US)

(72) Inventor: Gloria Bindelglass, Easton, CT (US)

(21) Appl. No.: 14/963,092

(22) Filed: Dec. 8, 2015

Related U.S. Application Data
(60) Provisional application No. 62/088,905, filed on Dec. 8, 2014.

(51) Int. Cl. G06F 19/00

(52) U.S. Cl. CPC G06F 19/323; G06F 19/3406; G06F 19/363

(57) ABSTRACT

An emergency mobile electronic guidance apparatus having a processor, a memory containing an exigent standard of care process associated with a patient, wherein the processor is configured to present, on a display, a plurality of codes defining different patient care actions associated with the exigent standard of care process, each different patient care wherein the processor is configured to collect, with the input device, patient care action performance information associated with each code and integrate the patient care action performance information to form a dynamic, real-time model of the patient's condition in the memory, wherein, the processor is further configured to display an at-a-glance representation of the current state of the exigent standard of care process and the patient's current condition based on the dynamic, real-time model, wherein the processor is further configure to generate prompts associated with each different patient care action.

### CROSS REFERENCE TO RELATED APPLICATIONS

This application is a non-provisional of and claims the benefit of U.S. provisional patent application No. 62/088,905 filed on Dec. 8, 2014, the disclosure of which is incorporated by reference herein in its entirety.

### BACKGROUND

1. Field

The present embodiment relates to a system to provide emergency guidance for an exigent standard of care process, and more particularly, to a system to provide emergency guidance for an exigent standard of care process for medical applications.

2. Brief Description of Related Developments

In the medical field, and especially within the field of emergency medicine, there are often predetermined exigent standards of care processes which are used by medical practitioners to protect patients. For the purposes of this application, medical practitioners can include, for example, doctors, emergency room personnel, nurses and other individuals who administer medical assistance to patients. Medical practitioners can also include pre-hospital responders such as, for example, emergency medical technicians (EMTs), paramedics, firefighters, nurse practitioners in the field and other first responders for medical emergencies. These exigent standard of care processes, such as, for example, the Advanced Cardiac Life Support (ACLS) protocols are often prescribe a predetermined process and procedure for treating or stabilizing certain medical conditions. In the case of ACLS, there are a number of exigent standards of care which are designed to stabilize and to treat patients undergoing cardiac arrest or cardiopulmonary distress. Because of the time-sensitive nature of treating cardiac arrests or cardiopulmonary distress, medical practitioners often must follow a precise protocol or standard of care process to stabilize a patient. These precise protocols often also have precise timing requirements for each of the patient care actions that form the exigent protocol or standard of care process. However, because of the chaotic nature of critical care or emergency medicine, it may be difficult to follow the protocol or standard of care process within the limited time (e.g. minutes or seconds) necessary to save a life. While medical practitioners and emergency personnel are well trained with regards to the standard of care processes needed to stabilize and save a patient, the convergence of multiple exigent patient care actions, as well as strict timing requirements in a hectic emergency room environment can lead to confusion and possible inadvertent oversights in timing or performance of patient care actions. This can result in steps being missed in the standard of care process or steps done in improper sequence. This can also result in the precise timing requirements not being followed. All of these can result in possible injury or death to a patient.

To maintain and properly carry out the predetermined standard of care for all patients, there is a need for an emergency guidance apparatus to ensure and maintain best practices for the exigent standard of care process. The apparatus should provide immediately understandable at-a-glance emergency guidance to maintain and control the queue performance of patient care actions in accordance with the standard of care process. The system should also time and generate prompts for medical practitioners and personnel to perform exigent patient care actions in accordance with the exigent standard of care process or protocol. The system should also audit and record patient care action performance, which allows hospitals and emergency room management to determine what aspects of the standard of care process could be improved. The system should also reinforce practices of and provides guidance for medical practitioners and emergency room personnel to carry out the standard of care process. The system also reinforces practices and provides guidance for pre-hospital responders such as, but not limited to, for example, EMTs, paramedics, firefighters, nurse practitioners in the field and other first responders for medical emergencies.

### BRIEF DESCRIPTION OF THE DRAWINGS

The foregoing aspects and other features of the present invention are explained in the following description, taken in connection with the accompanying drawings, wherein:

FIG. 1 is a schematic representation illustrating an overview of the standard of care management system in accordance with an aspect of the disclosed embodiment.

FIG. 2 is an exemplary user interface of a timer page in accordance with an aspect of the disclosed embodiment.

FIG. 3 is an exemplary user interface of a sequence of codes in accordance with an aspect of the disclosed embodiment.

FIG. 4 is an exemplary user interface of a sequence of codes in accordance with an aspect of the disclosed embodiment.

FIG. 5 is an exemplary user interface of an investigations page in accordance with an aspect of the disclosed embodiment.

FIG. 5a is an exemplary user interface of the investigations page in accordance with an aspect of the disclosed embodiment.

FIG. 6 is an exemplary user interface of a timer editing dialogue in accordance with an aspect of the disclosed embodiment.

FIG. 7 is a flow chart illustrating the operation of the standard of care management system in accordance with an aspect of the disclosed embodiment.

### DETAILED DESCRIPTION OF THE EXEMPLARY EMBODIMENT

The disclosed embodiment generally provides for a system for providing emergency guidance for managing and assisting the queuing of patient care actions for an exigent standard of care process. In one aspect of the disclosed embodiment, the system may be embodied in the form of a mobile device and an associated mobile application in memory that embodies the predetermined standard of care processes. In some aspects, the predetermined standard of care process are protocols associated with Advanced Cardiac Life Support, but in other aspects, any suitable exigent protocols or standard of care processes (e.g. standards of care requiring a critical acute response) may be managed and queued. The system further provides an apparatus with at-a-glance emergency guidance to inform the medical practitioner of the current state of the exigent standard of care process as well as the current condition of the patient. The system for managing and queuing the exigent standard of care process further allows for at-a-glance representation of timing criteria for taking certain exigent patient care actions and assists in queuing (i.e. controlling sequence and timing) exigent patient care actions in accordance with the exigent standard of care process. In one aspect of the disclosed embodiment, the system is linked to a hospital or healthcare facility information management system for communication with and registration of pertinent data. For example, performance of one or more patient care actions such as the administration of certain medicines or substances (i.e. epinephrine or amiodarone) to a patient is communicated to the hospital information management system. This information enables billing, record-keeping or other suitable purpose. In other aspects, this information is employed for practice and procedure auditing purposes. Although the present invention will be described with reference to the embodiment shown in the drawings, it should be understood that the present aspects of the disclosed embodiment can be used individually or in any suitable combination thereof. It should also be understood that the forgoing description is only illustrative of the embodiment. Various alternatives and modifications can be devised by those skilled in the art without departing from the embodiment. Accordingly, the present aspects are intended to embrace all such alternatives, modifications and variances.

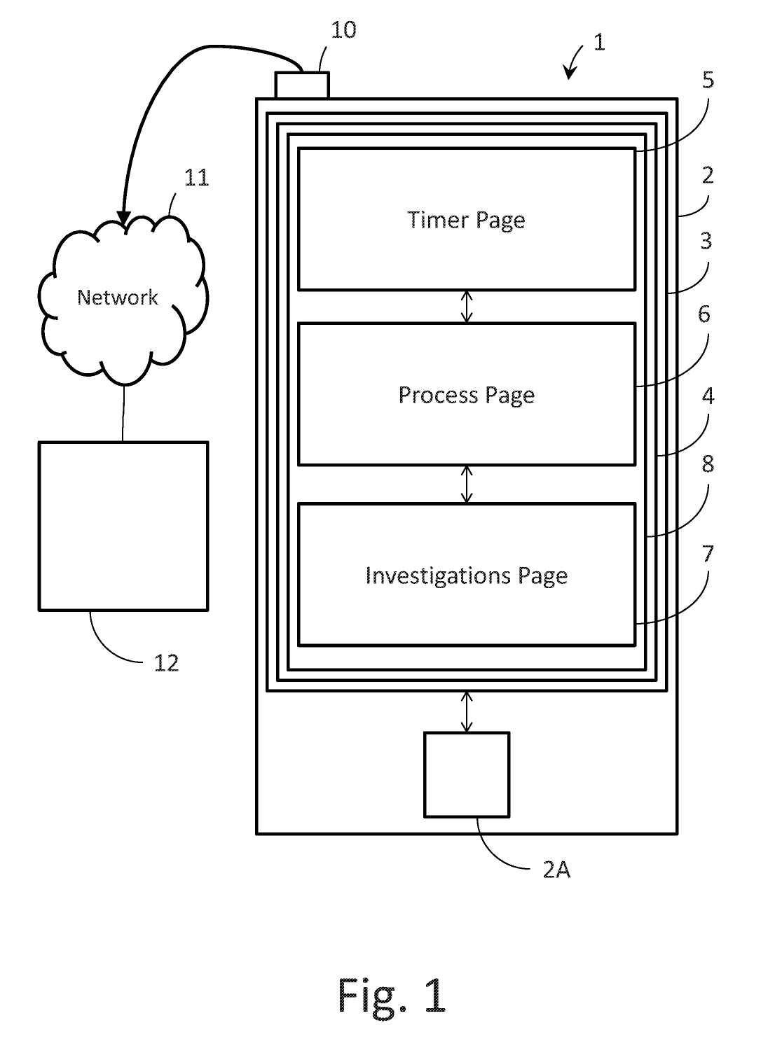

Referring now to FIG. 1, a schematic overview of the system 1 in accordance with an aspect of the disclosed embodiment is shown. The system 1 may be embodied in a mobile device 2 and a mobile application 4 in device memory 3 that stores one or more exigent standards of care process in some format. Here, the system 1 includes a mobile device 2, which has a processor 2a which executes a mobile application 4 stored within the memory 3. The mobile application 4 provides at-a-glance emergency guidance for medical practitioners to execute the exigent standard of care process and assists in queuing performance of patient care actions in accordance with the predetermined exigent standard of care process.

In one aspect, the mobile application 4 and the processor 2a generates a dynamic and real-time model 8 in memory 3 which models the patient's current condition and the current state of the exigent standard of care based on patient care action performance information. In one aspect, the processor 2a and the mobile application 4 also display at-a-glance representations of dynamic, real-time model 8 may be effected or operative in part or in entirety, by display on one or more display pages (e.g. the timers pages 5, the exigent standard of care process pages 6 and the investigations pages 7) as will be described below. The at-a-glance model representations are immediately understandable to a medical practitioner and allow for the medical practitioner to immediately ascertain, based on the dynamic, real-time model 8, the current state of the exigent standard of care process, what must be done within a certain immediate and limited period of time and the patient's current condition without needing extraneous direct interaction by the medical practitioner.

In one aspect, the timer page 5 presents a plurality of timers, each representing an exigent patient care action as will be described in greater detail below. The timer page 5 also presents, in one aspect, an at-a-glance representation of the dynamic, real-time model 8. The at-a-glance representation of the real-time model 8 is shown as, in one aspect, immediately ascertainable information that enables the medical practitioner to immediately determine the current stage or patient care action of the exigent standard of care that must be performed within the next few minutes or seconds, as well as at-a-glance information related to the time to perform the current stage or patient care action of the exigent standard of care process.

In one aspect, the mobile application 4 also presents one or more exigent standard of care process pages 6 defining one or more exigent standard of care processes having one or more exigent patient care actions to be performed by the medical practitioner. In one aspect, the exigent standard of care process pages 6 also provide an at-a-glance representation of the dynamic, real-time model 8, or a portion thereof, and present to a medical practitioner immediately identifiable information indicating what stage of an exigent standard of care process they are currently working on. In one aspect, each of the exigent standard of care process pages 6 are presented to a medical practitioner as a separate page of a user interface within the mobile application 4 and can, in one aspect, represent a portion of a exigent standard of care. Each page of the user interface (such as exigent standard of care process pages 6) contains a sequence of codes (also referred to as indicia), each code of which defines different patient care action associated with an exigent standard of care process for a predetermined medical condition (e.g. cardiac arrest, cardiac dysfunction, ventricular fibrillation (VF), ventricular tachycardia (VT), asystole, etc.) having one or more exigent patient care actions to be performed in a predetermined sequence and according to a specific immediate timing criteria. Each code of the sequence of codes represents and defines an different patient care action that forms part of the exigent standard of care process. In one aspect of the disclosed embodiment, each of the sequence of indicia of the exigent standard of care process pages 6 is represented by an associated timer of the timer page 5. In one aspect of the disclosed embodiment, the medical practitioner can activate a timer represented by one of the codes of the sequence of codes 4 from within exigent standard of care process page 6.

In one aspect of the disclosed embodiment, the mobile application 4 also presents one or more investigation pages 7 with a predetermined listing of potential causes associated with an exigent standard of care process corresponding to an exigent standard of care page 6. In one aspect of the disclosed embodiment, investigation pages 7 also provide an at-a-glance representation of the dynamic, real-time model 8 (or another portion thereof) by providing medical information related to the current state of the exigent standard of care process or the patient condition based on the dynamic, real-time model 8. The investigation pages 7, in one aspect, are used by medical practitioner to refer to for various causes associated with a standard of care process, but in other aspects, the investigation pages 7 could include other investigation items. As may be realized, one or more of the timer page 5, the exigent standard of care process pages 6 and the investigations pages 7, alone or in combination, provide an at-a-glance representation of the real-time model 8.

In one aspect of the disclosed embodiment, the mobile device 2 is a mobile smartphone. However, in other aspects, the mobile device 2 is any suitable computing device. This includes, for example, a desktop computer, a laptop computer, a tablet computer, or a fixed terminal within a hospital or emergency room environment. In yet other aspects, the mobile device 2 is a specialized device specifically to manage and queue a standard of care process. The processor 2a is any suitable processor configured to power and to control the operation of the mobile device 2. This includes x86-based processors, ARM-based processors, or specialized and/or customized processors specifically configured to manage and queue a standard of care process. The processor 1a is configured to control or execute a mobile application 4. In one aspect of the disclosed embodiment, the mobile device 2 is a standalone device that is not connected to a network. However, in other aspects, the mobile device 2 has a network interface module 11 which communicates with a hospital or healthcare information management system 12 via a network 11 through, for instance, WiFi, GSM, Bluetooth, RF, wired network connections or any other suitable network connections. In this aspect of the disclosed embodiment, the mobile device 2 enables the upload and download of patient information to the hospital or healthcare information management system 12.

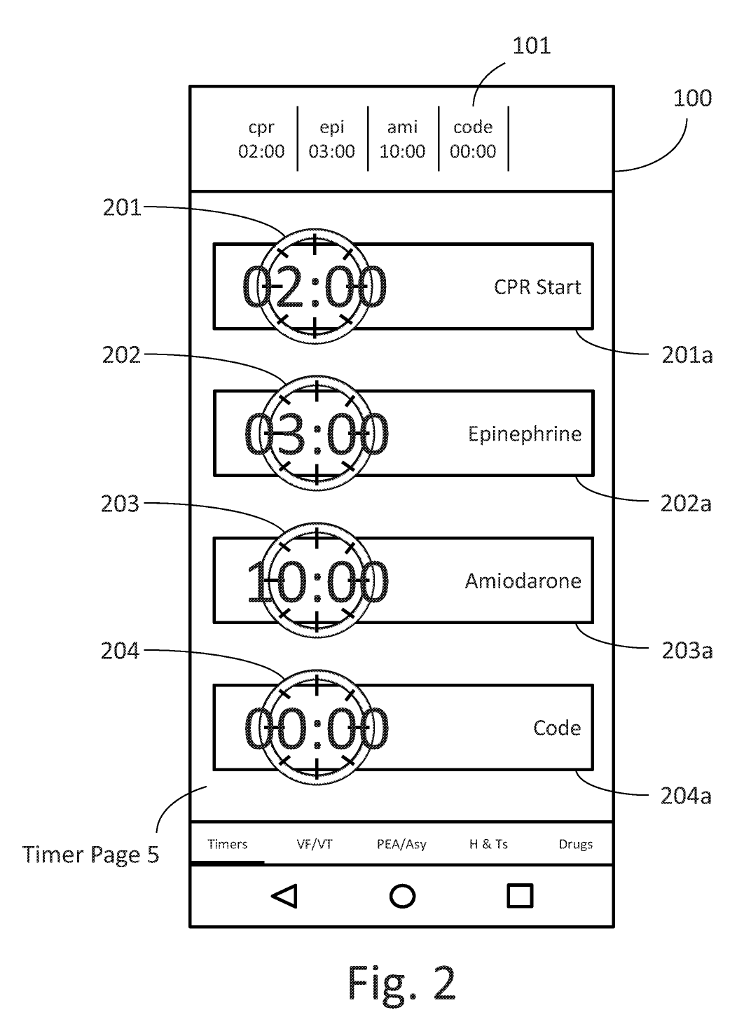

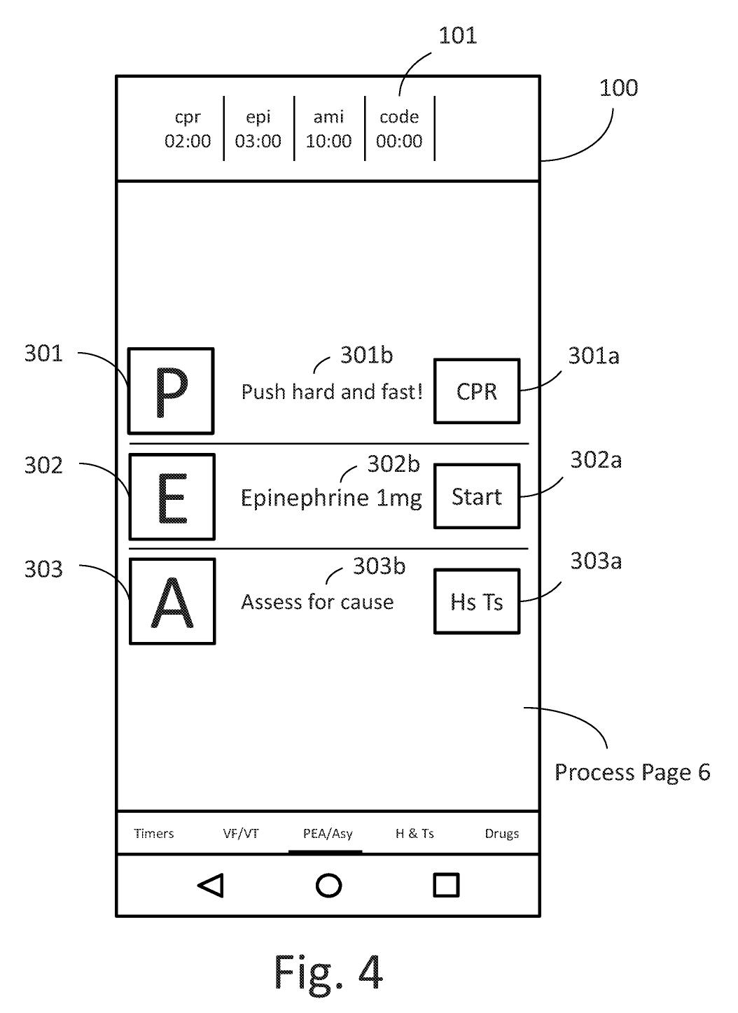

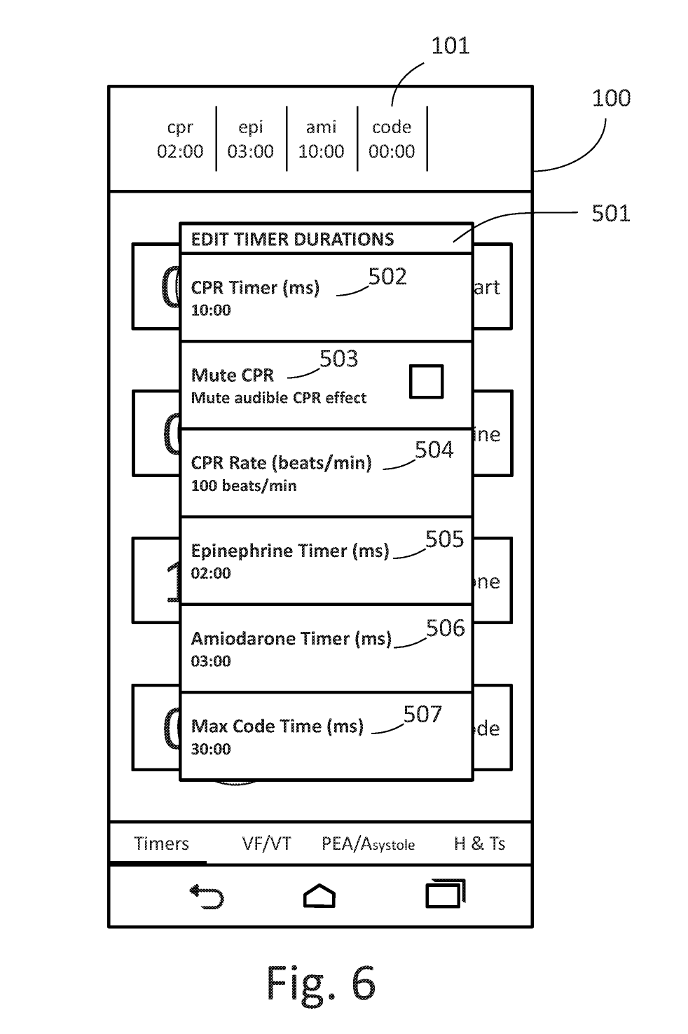

Referring now to FIGS. 1 and 2, the mobile application 4 first presents a timer page 5 presenting a plurality of timers 201-204. In one aspect, the timer page 5 is presented as the top or front page within the mobile application 4. For example, when the mobile application 4 is first launched, the first page shown to a medical practitioner is the timer page 5. As the top or front page of the mobile application 4, the timer page 5 provides an at-a-glance representation of the dynamic, real-time model 8 by showing immediately understandable information related to the current state of the exigent standard of care process and the patient's current condition. Each of the timers 201-204 represents a different exigent patient care action of an exigent standard of care process and the timeframe to perform each exigent patient care action. The timers 201-204, therefore, provide a medical practitioner with immediately understandable information about which exigent patient care action must be performed at any given moment (e.g. within the next few minutes or next few seconds). In one aspect, the plurality of timers 201-204 are represented as a countdown clock, but in other aspects, the plurality of timers 201-204 are represented in any suitable indicia. It is noted that the times shown in FIG. 2 with respect to timers 201-204 are shown purely for exemplary purposes. In some aspects, the timers 201-204 may have different times. In other aspects, the timers 201-204 can be edited or altered by a user or by hospital or health information management system 12. In yet other aspects, the timers 201-204 can run either up or down. In one aspect of the disclosed embodiment, the timing criteria for the timers 201-204 represent the time to perform a particular patient care action. This includes, for example, CPR timer 201, which sets forth a predetermined time period for performing CPR on a patient. However, in other aspects of the disclosed embodiment, the timing criteria for timers 201-204 is the time period between performing parts of a patient care action. For example, with respect to Epinephrine timer 202 and Amiodarone timer 203, the timing criteria are the periods between administering multiple doses of each medication. In one aspect of the disclosed embodiment, the timing criteria for timers 201-204 can be manually edited with an Edit Timer Duration option popup 501 shown in FIG. 6. The Edit Timer Duration option popup 501 presents editable timer values 502, 505, 506 and 507 which correspond to the respective timing criteria for timers 201-204. However, in other aspects of the disclosed embodiment, each sequence of codes 4, 4a, 4b sends different timing criteria to timers 201-204 based on the standard of care process being employed. For example, the timing criteria for the CPR timer is different for the “SCREAM” exigent standard of care process shown in FIG. 2 is different from the timing criteria for the CPR timer used in the “PEA” exigent standard of care process shown in FIG. 4. Referring still to FIG. 2, the plurality of timers 201-204 can be activated manually within the timer page 5 of by activating selectable elements such as the timer activation buttons 201a-204a, which correspond to timers 201-204 respectively. In one aspect, activating one of the timer activation buttons 201a-204a causes one or more of the timers 201-204 to start, reflecting the multi-tasking nature of the exigent standard of care process. In one aspect, the timer activation buttons 201a-204a is color coded to match an exigent patient care action presented on one of the exigent standard of care process pages 6 described below. In one aspect, the timer activation buttons 201a-204a is recorded by the processor as patient care action performance information, which is integrated into the dynamic, real-time model 8 to update the dynamic, real-time model. In some aspects, the processor may highlight, or flash or otherwise make visual indications of timers 201-204 which are currently active or currently require a medical practitioner's attention. In other aspects, the processor can also generate audio prompts as the timers 201-204 are running.

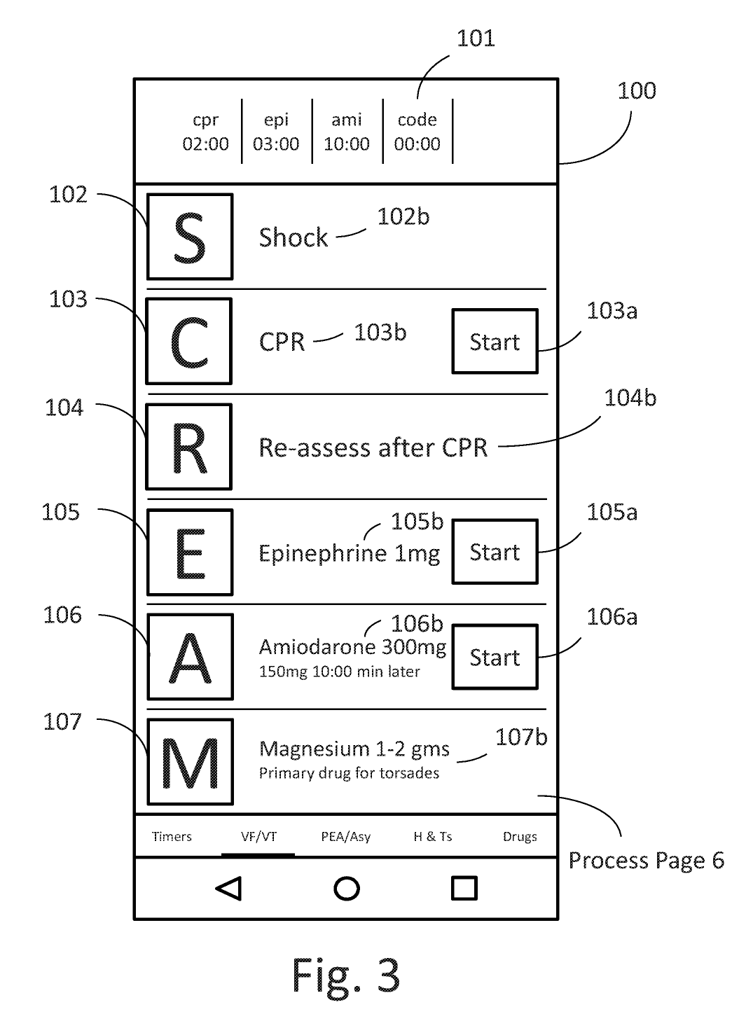

Referring now to FIGS. 1, 3 and 4, the mobile application 4 also presents one or more exigent standard of care process pages 6. In one aspect, the exigent standard of care process pages 6 are positioned after or next in sequence with respect to the timer page 5 within the mobile application 4. The exigent standards of care process pages 6 also provide an at-a-glance representation of the dynamic, real-time model 8. For example, the exigent standard of care process pages 6 allows a medical practitioner to immediately identify and understand what stage of an exigent standard of care process the medical practitioner is currently working on. The exigent standard of care process pages 6 also allows a medical practitioner to identify, at-a-glance, which exigent patient care actions have already been performed and which exigent patient care actions are coming up. In other aspects, the exigent standard of care process pages 6 also presents a current state of the patient based on the dynamic, real-time model 8. As noted above, the exigent standard of care process pages 6 each contain a different exigent standard of care protocol represented by, for example, a sequence of code 102-107 and 301-303, where each code 102-107 and 301-303 defining a different patient care action associated with an exigent standard of care. Each sequence of indicia 102-107 and 301-303 defines a protocol for a predetermined exigent standard of care process having one or more exigent patient care actions that is performed in a predetermined sequence and according to a predetermined timing criteria. In one aspect of the disclosed embodiment, each indicia of the sequence of code 102-107 and 301-303 represents and defines an exigent patient care action within the exigent standard of care process. Each code is also represented by an alphanumeric character arranged in an immediately recognizable alphanumeric pattern defining a recognizable feature related to the standard of care process. In one aspect, the recognizable alphanumeric pattern forms a mnemonic where each code corresponds to and defines a patient care action in a standard of care process. In aspect, each code 102-107 of the sequence of codes 102-107 is followed by a caption text 102b-107b or explanation of the exigent patient care action (e.g. “Shock” for “S”). One example of the sequence of codes 102-107 is shown in FIG. 3 which presents a sequence of codes 102-107 represented by the alphanumeric characters “S-C-R-E-A-M.” Each code of the sequence of codes 102-107 shown in FIG. 2 defines a different exigent patient care action that forms part of the exigent standard of care process. In another example of a different sequence of sequence of codes 301-303 is shown in FIG. 4, where the sequence of codes 301-303 is represented by the alphanumeric characters “P-E-A.” In one aspect, each exigent patient care action of the exigent standard of care process shown in FIGS. 3 and 4 correspond to one of the timers 201-204 of the timers page 5. In one aspect, a timer associated with one or more codes of the sequence of codes 102-107 and 301-303 can be activated from within the exigent standard of care process page 6.

Referring again to FIG. 3, an exemplary sequence of codes 102-107 associated with the SCREAM exigent standard of care process for ACLS is shown with respect to an exemplary exigent standard of care process page 6. The SCREAM exigent standard of care process is a standard of care process for treating and stabilizing patients undergoing ventricular fibrillation or pulseless ventricular tachycardia. FIG. 3 illustrates a page within the mobile application 4. In one aspect, the exigent standard of care process page 6 has a universal display of timers 101 associated with a exigent standard of care process for quick reference. In one aspect, the universal display of timers 101 correspond to the timers 201-204 of the timers page 5. Each of the codes 102-107 defines a different patient care action that is to be performed in association with the “SCREAM” standard of care process. The “S” code 102 represents a patient care action of “Shock” which instructs a medical practitioner to “shock” or provide electrocardiac stimulation on a patient. In some aspects, the “S” code 102 may include a selectable element to activate a shock timer (not shown) associated with and corresponding to the “S” code 102 to from within the sequence of codes 102-107 to provide medical practitioners with timing guidance for performing electrocardiac shocks on a patient. However, in other aspects, there is no option to activate a shock timer associated with the “S” code 102. As may be realized, the “S” code remains nonetheless associated with and corresponds to the code timer 204 (e.g. on the timer page 15, see FIG. 2, and exigent standard of care process pages 6). Similarly, other codes on the process exigent standard of care process pages 6 and investigations pages 7 that do not have a dedicated corresponding timer are otherwise associated with and correspond to at least the code timer 204. The “C” code 103 represents a patient care action of “Perform CPR” which instructs a medical practitioner to initiate CPR on a patient. The “C” code is associated with and corresponds to the CPR timer 201 (see FIG. 2) dedicated to code 103. In one aspect of the disclosed embodiment, a selectable CPR timer 201 (see FIG. 2) activation button 103a can be activated by a medical practitioner from within the sequence of codes 4a. Activation of the CPR Timer activation button 103a starts the CPR Timer 201 on the timer page 5 (see FIG. 2), which initiates a countdown according to a predetermined timing criteria associated with the “C” Code 103 patient care action. In one aspect, the CPR timer 201 will initiate a countdown and provide audio-visual feedback for the predetermined timing criteria for “C” Code 103 patient care action. The CPR timer 201 also generates prompts or alerts on the page of the mobile application 4 containing the sequence of codes 101-107 shown in FIG. 3 to prompt a medical practitioner to stop performing CPR. The “R” code 104 represents a patient care action of “Reassessing after CPR.” The “R” code 104 instructs the medical practitioner to assess whether a patient should be administered more electrocardiac stimulation if the patient remains pulseless. In one aspect of the disclosed embodiment, the “R” code 104 has an associated Reassessment timer to limit the time medical practitioners take to reassess the patient status. However, in other aspects, there is no dedicated timer associated with the “R” code 104 and the “R” code's corresponding timer is code timer 204 (see FIG. 2). The “E” code 105 defines a patient care action of “Epinephrine.” The “E” code 105 instructs the medical practitioner to inject the patient with Epinephrine after performing the “R” code 104. In one aspect, there is an Epinephrine Timer activation button 105 which enables a medical professional to activate the Epinephrine timer 202 shown in FIG. 2 from the exigent standard of care process page 6. In one aspect, the Epinephrine timer 202 will initiate a countdown and provide audio-visual feedback for the predetermined timing criteria for “E” code 105 patient care action. In one aspect, the timer 202 generates prompts or alerts on the sequence of code 101-107 page shown in FIG. 3 to prompt a medical practitioner with timing guidance to administer multiple doses of Epinephrine. The “A” code 106 represents a patient care action of “Amiodarone.” In one aspect of the disclosed embodiment, there is an Amiodarone timer activation button 106a which enables a medical professional to activate the Amiodarone timer 203 shown in FIG. 3 from the sequence of code 4a. In one aspect, the activation of the corresponding dedicated timer 203 (see FIG. 2) Amiodarone Timer will initiate a countdown and provide audio-visual feedback for the predetermined timing criteria for the “A” code 106 patient care action. In one aspect, the timing criteria for the “A” code 106 patient care action corresponds with the timing criteria for a medical practitioner to administer a second dose of Amiodarone after initiating an initial dose to the patient. The “M” code 107 represents “Magnesium.” The “M” code 107 instructs the medical practitioner to initiate the administration of antiarrhythmic drugs like Magnesium Sulfate. In one aspect of the disclosed embodiment, there is a timing criteria associated with the “M” code 107 patient care action similar to that described previously. However, in other aspects, there is no dedicated sole timer timing criteria associated with the “M” code 107 patient care action other than the code timer 204. In one aspect, the selectable timer activation buttons 103a, 15a and 106a are color coded to match a corresponding timer from the timer page 5. It should also be noted that the selectable timer activation buttons 103a, 105a and 106a also allow the mobile application 4 to receive a patient care action performance information with respect to the codes. It should also be noted that some codes may not have an associated selectable element or timer activation button and does not receive a patient care action performance information. In one aspect, the received patient care action performance information is integrated into the dynamic, real-time model 8 to update the current state of the exigent standard of care process and the patient's current condition. It should be noted that, in some aspects of the disclosed embodiment, the patient care action performance information associated with the sequence of code 4a is recorded (e.g. activation of timers associated with each exigent patient care action) and communicated to a hospital information management system 12 for billing and performance auditing purposes.

Referring now to FIG. 4, another exemplary sequence of codes 301-303 associated with a different portion of the standard of care process is shown. The sequence of codes 301-303 defines the exigent standard of care process for the PEA portion of the ACLS exigent standard of care process. The PEA is an exigent standard of care process for treating and stabilizing patients who exhibit no palpable pulse (e.g. asystole), usually after the patient has experienced defibrillation. User interface 100 of the mobile application 4 in FIG. 4 shows of the sequence of codes 301-303, each of which defines a different patient care action of the PEA standard of care process. “P” Code 301 represents “Push Hard and Fast.” The “P” Code 301 instructs the medical practitioner to perform patient care action of rapid chest compression (PUSH) and perform CPR to attempt to restart a cardiac rhythm. As noted above, the mobile application 4 can also receive patient care action performance information associated with each different patient care action through the timer activation buttons 301a-303a. It should also be noted that some codes may not have an associated selectable element or timer activation button (but otherwise corresponds to the code timer 204 as described previously) and does not receive a patient care action performance information. In one aspect of the disclosed embodiment, there is a CPR timer activation button 301a which enables a medical professional to activate the CPR timer 201 shown in FIG. 3 from the sequence of codes 4b. In one aspect, the CPR timer activation button 301a has a different timing criteria and duration compared to the CPR timer activator button 103a. This different timing and duration reflects the different timing criteria associated with the “P” Code 301 patient care action and the “C” Code 103 patient care action used with sequence of codes 4a. However, in other aspects, the CPR timer activation button 301a and CPR timer activator button 103a may activate the CPR timer 201 with the same timing criteria. The “E” Code 302 represents “Epinephrine.” The “E” Code 302 instructs the medical practitioner to perform the patient care action of administering Epinephrine. In one aspect of the disclosed embodiment, there is an Epinephrine timer activation button 302a which enables a medical professional to activate the Epinephrine timer 202 shown in FIG. 3 from the sequence of codes 4b. Activation of the Epinephrine timer 202 starts a timer countdown which provides guidance on administering a first and second dose of Epinephrine. As with the CPR Timer activation button 301a, in one aspect of the disclosed embodiment, the Epinephrine timer activation button 302a may activate the Epinephrine timer 202 with a different timing criteria than the Epinephrine timer activation button 105a in FIG. 1. However, in other aspects, the timing criteria is the same. The “A” Code 302 represents “Assess for Cause.” The “A” Code 302 instructs the medical practitioner to assess a patient for causes of asystole or lack of pulse. In one aspect, this includes requesting the medical practitioner to check through a list of potential causes in the Investigations pages 6 of the mobile application 4. In one aspect, the selectable timer activation buttons 301a-303a are color coded to match a corresponding timer from the timer page 5. It should be noted that, in some aspects of the disclosed embodiment, performance of each patient care action within the sequence of codes 4b e.g. activation of timers associated with each Patient Care action) is recorded and communicated to a hospital information management system 12 for billing and performance auditing purposes.

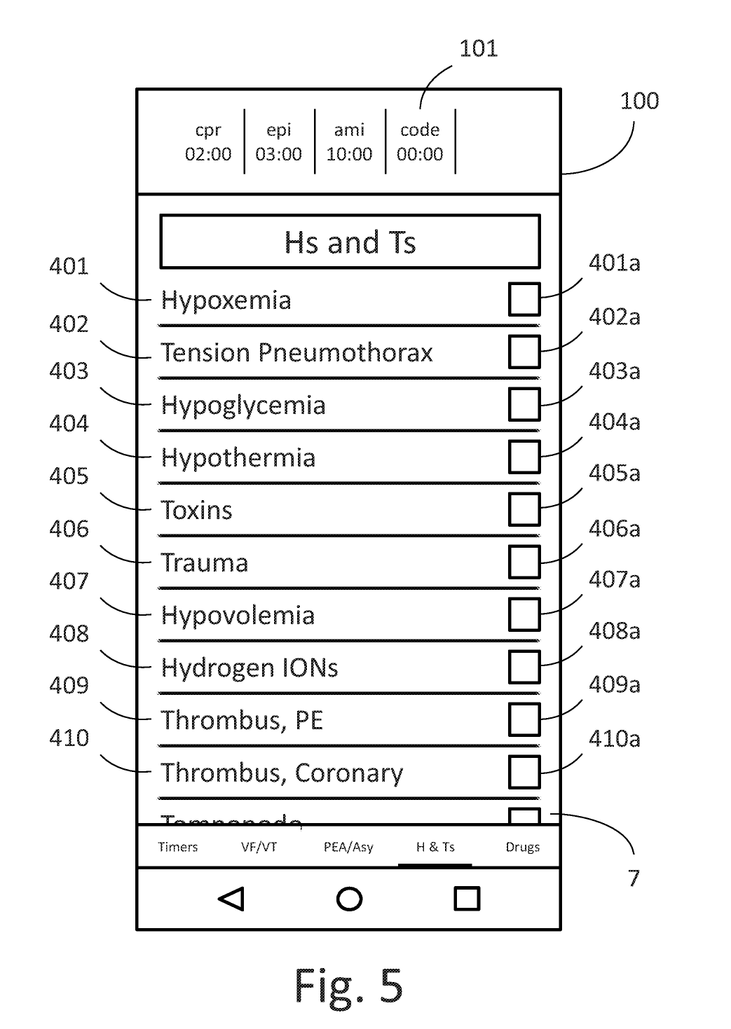

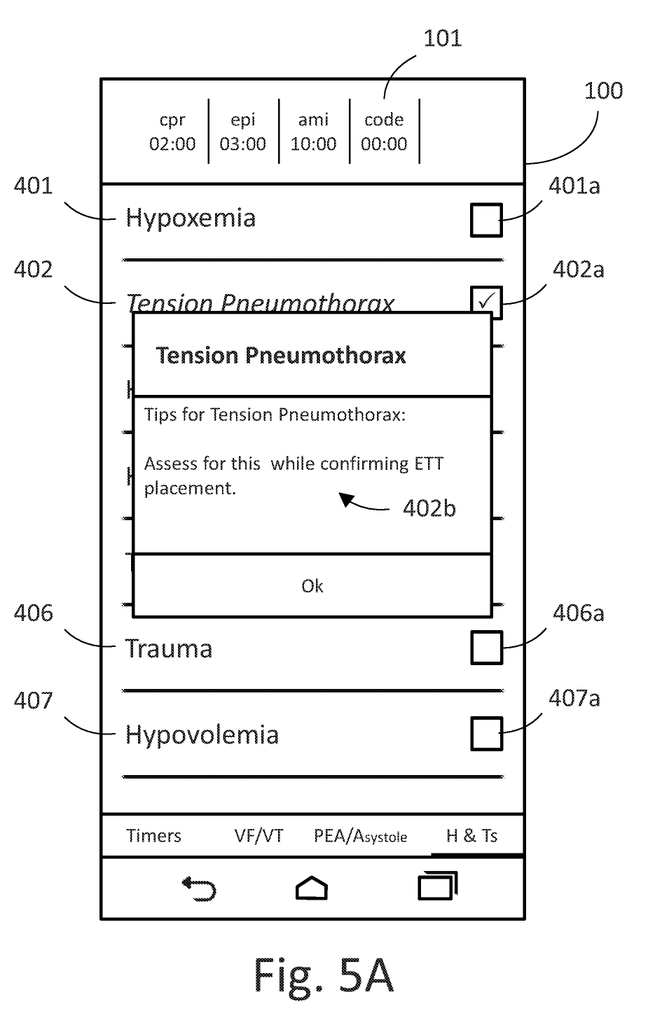

Referring now to FIGS. 5 and 5A, the investigations page 7 of the mobile application 4 is shown. In one aspect, the investigations page also provides a representation of at least a part of the dynamic, real-time model 8 and provides at-a-glance information related to possible causes of cardiac distress based on the current state of the exigent process and the patient's current condition. In one aspect, the investigations page 7 of the mobile application includes a listing of potential causes 401-4010. In the context of the PEA algorithm shown in FIG. 4, the investigations page 7 includes potential listings of causes for pulselessness and/or asystole. However, in other aspects of the disclosed embodiment, the Investigations page 7 includes other causes for other ailments and other standard of care processes. Each listing of potential causes 401-410 is associated with a selection element 401a-410a. In one aspect of the disclosed embodiment, when a listing 401-410 is selected by a medical practitioner, the user interface 100 of the mobile application 4 generates a popup dialogue. Referring specifically to FIG. 5A, a popup dialogue 402b is shown. The popup dialogue 402b is associated with a selected hidden selection element 402a which is, in turn, associated with listing 402 for Tension Pneumothorax. In one aspect, the popup dialogue 402b includes hints and procedural suggestions for selecting the selected listing 402. However, in other aspects, the popup dialogue includes diagnostic data, procedural instructions, illustrations or any other suitable information pertaining to each listing of potential causes. In one aspect, the investigations pages 7 are dynamically updated with information based on the dynamic, real-time model 8 of the current state of the exigent patient care process and the patient's current condition.

It is noted that the patient care action performance information related to an exigent standard of care process are protected in compliance with Health Insurance Portability and Accountability Act (HIPAA) standards.

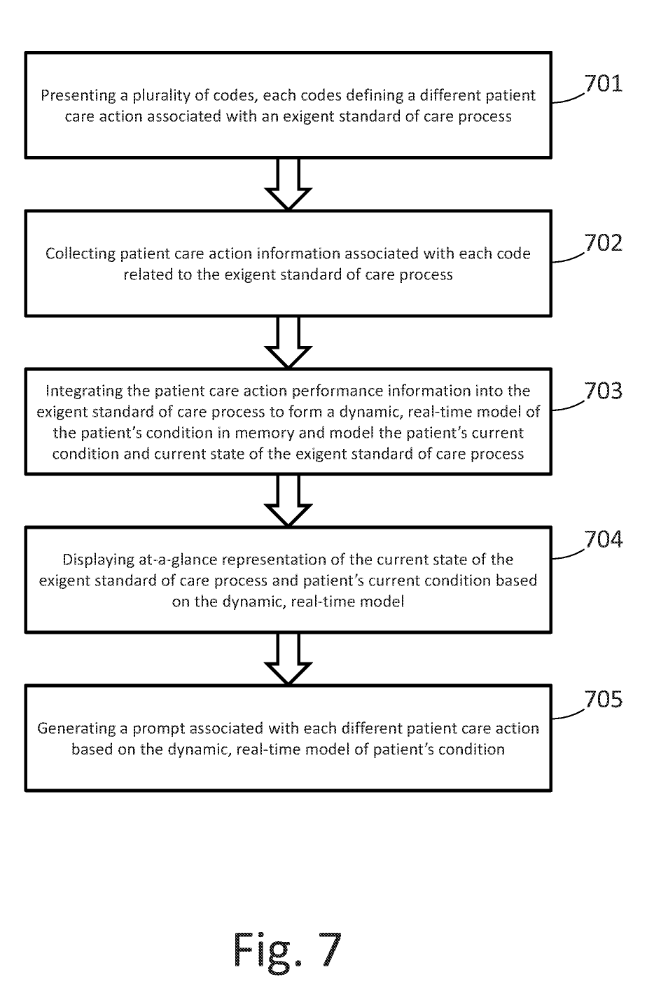

Referring now to FIG. 7, a flow chart illustrating the operation of the standard of care management system is shown. At block 701, the mobile application 4 presents, on a display, a plurality of codes. Each code of the plurality of codes defines a different patient care action associated with an exigent standard of care process. Each different patient care action further associated with a timer, where the plurality of codes is arranged in a recognizable alphanumeric pattern defining a recognizable feature. In one aspect, the plurality of codes is a visual mnemonic used by the medical practitioner. At block 702, the mobile application 4 collects, with an input device, patient care action performance information associated with each code related to the exigent standard of care process. In one aspect, this could be, for example, inputting in the mobile application 4 the start and end times when a patient care action is performed by the medical examiner. At block 703, the mobile application 4 integrates the patient care action performance information into the exigent standard of care process to form a dynamic, real-time model of the patient's condition in memory and model the patient's current condition and the current state of the exigent standard of care process. At block 704, the mobile application 4 displays at-a-glance representation of the current state of the exigent standard of care process and the patient's current condition based on the dynamic, real-time model. In one aspect, the mobile application 4 presents the patient's current condition and the current state of the exigent standard of care process on the timer page 5, the exigent standard of care process pages 6 and the investigations pages 7. At block 705, the mobile application 4 generates a prompt associated with each different patient care action based on the dynamic, real-time model of the patient's condition to control and queue performance of each different patient care action associated with its respective timer.

In accordance with one or more aspects of the disclosed embodiment, a mobile electronic guidance apparatus is disclosed having a processor configured to control a standard of care process; wherein the processor is configured to present a plurality of codes, each code defining a different patient care action associated with the standard of care process, the plurality of codes is arranged in a recognizable alphanumeric pattern defining a recognizable feature related to the standard of care process; wherein the processor is further configured to define and track a plurality of timers, each timer associated with a state of a different corresponding one of the plurality of codes, each timer further associated with a different timing criteria for the associated patient care action; wherein the processor generates prompts based on the plurality of timers to control and queue performance of the patient care action associated with each timer.

In accordance with one or more aspects of the disclosed embodiment, the processor is configured to present a plurality of codes on one or more pages.

In accordance with one or more aspects of the disclosed embodiment, the plurality of codes is arranged in a recognizable alphanumeric pattern represent a mnemonic.

In accordance with one or more aspects of the disclosed embodiment, each code of the plurality of codes define a step within the standard of care process

In accordance with one or more aspects of the disclosed embodiment, the processor is configured to generate a record of patient care actions performed in association with the plurality of timers

In accordance with one or more aspects of the disclosed embodiment, the processor is configured to present a plurality of investigation causes.

In accordance with one or more aspects of the disclosed embodiment, a mobile electronic guidance apparatus is disclosed having a processor configured to present a plurality of codes defining a standard of care process, each of the plurality of codes defining a patient care action of the standard of care process; wherein, the processor is configured to associate a timer to a predetermined code of the plurality of codes, the timer defining a timing criteria for the patient care action associated with the predetermined code; wherein, the processor is configured to generate a prompt controlling the performance of the associated patient care action based on the timer.

In accordance with one or more aspects of the disclosed embodiment, the processor is configured to present a plurality of codes on one or more pages.

In accordance with one or more aspects of the disclosed embodiment, the plurality of codes is arranged in a recognizable alphanumeric pattern represent a mnemonic.

In accordance with one or more aspects of the disclosed embodiment, each code of the plurality of codes define a step within the standard of care process

In accordance with one or more aspects of the disclosed embodiment, the processor is configured to generate a record of patient care actions performed in association with the plurality of timers

In accordance with one or more aspects of the disclosed embodiment, the processor is configured to present a plurality of investigation causes.

In accordance with one or more aspects of the disclosed embodiment, a method for controlling a standard of care process includes initializing one or more different sequences of codes with a mobile application, where each of the one or more different sequences of codes is arranged in a recognizable alphanumeric pattern defining a recognizable feature related to a standard of care process; selecting one sequence of codes from the one or more different sequences of code with the mobile application; activating a timer, within the one sequence of codes, corresponding to a timing criteria associated with a specific code of the one sequence of codes; and generating a prompt associated with the specific code based on a state of the timer and the timing criteria with the mobile application. Each code of the one or more different sequences of codes defines a patient care action associated with the standard of care process.

In accordance with one or more aspects of the disclosed embodiment, one of the one or more different sequences of code defines a SCREAM process for stabilizing ventricular fibrillation and/or pulseless ventricular tachycardia.

In accordance with one or more aspects of the disclosed embodiment, one of the one or more different sequences of code defines a PEA process for stabilizing pulseless asystole.

In accordance with one or more aspects of the disclosed embodiment, the method further includes presenting a plurality of investigation causes associated with the one or more different sequences of codes with the mobile application.

In accordance with one or more aspects of the disclosed embodiment, the method further includes presenting a plurality of timers with the mobile application, where each timer of the plurality of timers corresponds to the timing criteria of an associated code of the one or more different sequence of codes.

In accordance with one or more aspects of the disclosed embodiment, the method further includes generating a prompt includes audio-visual cues.

In accordance with one or more aspects of the disclosed embodiment, an emergency mobile electronic guidance apparatus includes a processor, a memory containing an exigent standard of care process associated with a patient, a display, and an input device, wherein the processor is configured to present, on the display, a plurality of codes, each code defining a different patient care action associated with the exigent standard of care process, each different patient care action further associated with a timer, the plurality of codes is arranged in a recognizable alphanumeric pattern defining a recognizable feature related to the standard of care process, wherein the processor is configured to collect, with the input device, patient care action performance information associated with each code defining the different patient care action, and integrate the patient care action performance information into the exigent standard of care process associated with the patient stored on the memory to form a dynamic, real-time model of the patient's condition in the memory, where the dynamic, real-time model models the patient's current condition and a current state of the exigent standard of care process based on the patient care action performance information collected with the input device, wherein, the processor is further configured to display an at-a-glance representation of the current state of the exigent standard of care process and the patient's current condition based on the dynamic, real-time model, wherein the processor is further configure to generate prompts associated with each different patient care action, based upon a state of the dynamic, real-time model of the patient's condition, to control and queue performance of each different patient care action associated with the timer.

In accordance with one or more aspects of the disclosed embodiment, wherein the processor is configured to present more than one plurality of codes, each plurality of codes associated with a different portion of the standard of care process.

In accordance with one or more aspects of the disclosed embodiment, wherein, the plurality of codes is arranged in an immediately recognizable alphanumeric pattern corresponding to a mnemonic.

In accordance with one or more aspects of the disclosed embodiment, wherein, each code of the plurality of codes define a step within the exigent standard of care process.

In accordance with one or more aspects of the disclosed embodiment, wherein, the processor is configured to generate a record of patient care action performance information associated with each code defining the different patient care actions.

In accordance with one or more aspects of the disclosed embodiment, wherein, the processor is configured to display a plurality of investigation causes.

In accordance with one or more aspects of the disclosed embodiment, an emergency mobile electronic guidance apparatus includes a processor, a memory containing an exigent standard of care process, associated with a patient, includes of a sequence of exigent patient care actions, a display, wherein the processor is configured to display a front page, the front page providing a plurality of timers each of the plurality of timers representing a corresponding one of the exigent patient care actions, the front page further presents an at-a-glance representation of each exigent patient care action and a timeframe for performing each exigent patient care action, wherein the processor is configured to display a next page, the next page providing an at-a-glance representation of the sequence of exigent patient care actions, where the sequence of critical patient care actions is represented by a sequence of indicia arranged in an immediately recognizable alphanumeric pattern related to the exigent standard of care process, the next page further identifies, at-a-glance, each current exigent patient care action of the sequence of critical patient care actions based on its respective timer, wherein the processor is further configured to generate a prompt to queue and control performance of each current exigent patient care action based on its respective timer.

In accordance with one or more aspects of the disclosed embodiment, wherein, the processor is configured to present more than one sequence of indicia on one or more pages.

In accordance with one or more aspects of the disclosed embodiment, wherein, the sequence of indicia is arranged in an immediately recognizable alphanumeric pattern representing a mnemonic.

In accordance with one or more aspects of the disclosed embodiment, wherein, each code of the sequence of indicia define a step within the exigent standard of care process.

In accordance with one or more aspects of the disclosed embodiment, wherein, the processor is configured to receive patient care performance actions associated with the sequence of indicia from an input device and generate a record of the patient care performance actions based on the dynamic, real-time model of the patient's condition.

In accordance with one or more aspects of the disclosed embodiment, wherein, the processor is configured to present a plurality of investigation causes.

In accordance with one or more aspects of the disclosed embodiment, a method for controlling a standard of care process includes presenting, on a display, a plurality of codes, each code defining a different patient care action associated with an exigent standard of care process, each different patient care action further associated with a timer, where the plurality of codes is arranged in a recognizable alphanumeric pattern defining a recognizable feature, collecting, with an input device, patient care action performance information associated with each code defining the different patient care action, integrating the patient care action performance information into the exigent standard of care process associated with the patient to form a dynamic, real-time model of the patient's condition in a memory, where the dynamic, real-time model models the patient's current condition and a current state of the exigent standard of care process based on the patient care action performance information, displaying an at-a-glance representation of the current state of the exigent standard of care process and the patient's current condition based on the dynamic, real-time model, and generating a prompt associated with each different patient care action, based upon a state of the dynamic, real-time model of the patient's condition to control and queue performance of each different patient care action associated with the timer.

In accordance with one or more aspects of the disclosed embodiment, wherein, the plurality of codes define a SCREAM process for stabilizing ventricular fibrillation and/or pulseless ventricular tachycardia.

In accordance with one or more aspects of the disclosed embodiment, wherein, the plurality of codes defines a PEA process for stabilizing pulseless asystole.

In accordance with one or more aspects of the disclosed embodiment, the method further includes presenting a plurality of investigation causes associated with the plurality of codes.

In accordance with one or more aspects of the disclosed embodiment, the method further includes presenting a plurality of timers, where each timer of the plurality of timers corresponds to a different patient care action.

In accordance with one or more aspects of the disclosed embodiment, the method further includes generating a prompt includes audio-visual cues.

It should be understood that the foregoing description is only illustrative of the aspects of the disclosed embodiment. Various alternatives and modifications can be devised by those skilled in the art without departing from the aspects of the disclosed embodiment. It should also be understood that the flowcharts disclosed within are only illustrative of the aspects of the disclosed embodiment. The actions described in the flowcharts may not be performed strictly in the sequence disclosed within each flowchart. Various alternatives and modifications can be devised by those skilled in the art without departing from the aspects of the disclosed embodiment shown in the flowcharts. Accordingly, the present aspects of the disclosed embodiment are intended to embrace all such alternatives, modifications and variances.

What is claimed is:

1. An emergency mobile electronic guidance apparatus comprising:
a processor;
a memory containing an exigent standard of care process associated with a patient;
a display; and
an input device;
wherein the processor is configured to present, on the display, a plurality of codes, each code defining a different patient care action associated with the exigent standard of care process, each different patient care action further associated with a timer, the plurality of codes is arranged in a recognizable alphanumeric pattern defining a recognizable feature related to the standard of care process;
wherein the processor is configured to collect, with the input device, patient care action performance information associated with each code defining the different patient care action, and integrate the patient care action performance information into the exigent standard of care process associated with the patient stored on the memory to form a dynamic, real-time model of the patient's condition in the memory, where the dynamic, real-time model models the patient's current condition and a current state of the exigent standard of care process based on the patient care action performance information collected with the input device;
wherein, the processor is further configured to display an at-a-glance representation of the current state of the exigent standard of care process and the patient's current condition based on the dynamic, real-time model;
wherein the processor is further configure to generate prompts associated with each different patient care action, based upon a state of the dynamic, real-time model of the patient's condition, to control and queue performance of each different patient care action associated with the timer.

2. The apparatus of claim 1, wherein the processor is configured to present more than one plurality of codes, each plurality of codes associated with a different portion of the standard of care process.

3. The apparatus of claim 1, wherein, the plurality of codes is arranged in an immediately recognizable alphanumeric pattern corresponding to a mnemonic.

4. The apparatus of claim 1, wherein, each code of the plurality of codes define a step within the exigent standard of care process.

5. The apparatus of claim 1, wherein, the processor is configured to generate a record of patient care action performance information associated with each code defining the different patient care actions.

6. The apparatus of claim 1, wherein, the processor is configured to display a plurality of investigation causes.

7. An emergency mobile electronic guidance apparatus comprising:
a processor;
a memory containing an exigent standard of care process, associated with a patient, comprising of a sequence of exigent patient care actions;
a display;
wherein the processor is configured to display a front page, the front page providing a plurality of timers each of the plurality of timers representing a corresponding one of the exigent patient care actions, the front page further presents an at-a-glance representation of each exigent patient care action and a timeframe for performing each exigent patient care action;
wherein the processor is configured to display a next page, the next page providing an at-a-glance representation of the sequence of exigent patient care actions, where the sequence of critical patient care actions is represented by a sequence of indicia arranged in an immediately recognizable alphanumeric pattern related to the exigent standard of care process, the next page further identifies, at-a-glance, each current exigent patient care action of the sequence of critical patient care actions based on its respective timer;
wherein the processor is further configured to generate a prompt to queue and control performance of each current exigent patient care action based on its respective timer.

8. The apparatus of claim 7, wherein, the processor is configured to present more than one sequence of indicia on one or more pages.

9. The apparatus of claim 7, wherein, the sequence of indicia is arranged in an immediately recognizable alphanumeric pattern representing a mnemonic.

10. The apparatus of claim 7, wherein, each code of the sequence of indicia define a step within the exigent standard of care process.

11. The apparatus of claim 7, wherein, the processor is configured to receive patient care performance actions associated with the sequence of indicia from an input device and generate a record of the patient care performance actions based on the dynamic, real-time model of the patient's condition.

12. The apparatus of claim 7, wherein, the processor is configured to present a plurality of investigation causes.

13. A method for controlling a standard of care process comprising:
presenting, on a display, a plurality of codes, each code defining a different patient care action associated with an exigent standard of care process, each different patient care action further associated with a timer, where the plurality of codes is arranged in a recognizable alphanumeric pattern defining a recognizable feature;
collecting, with an input device, patient care action performance information associated with each code defining the different patient care action;
integrating the patient care action performance information into the exigent standard of care process associated with the patient to form a dynamic, real-time model of the patient's condition in a memory, where the dynamic, real-time model models the patient's current condition and a current state of the exigent standard of care process based on the patient care action performance information;
displaying an at-a-glance representation of the current state of the exigent standard of care process and the patient's current condition based on the dynamic, real-time model; and
generating a prompt associated with each different patient care action, based upon a state of the dynamic, real-time model of the patient's condition to control and queue performance of each different patient care action associated with the timer.

14. The method of claim 13, wherein, the plurality of codes define a SCREAM process for stabilizing ventricular fibrillation and/or pulseless ventricular tachycardia.

15. The method of claim 13, wherein, the plurality of codes defines a PEA process for stabilizing pulseless asystole.

16. The method of claim 13, the method further comprising presenting a plurality of investigation causes associated with the plurality of codes.

17. The method of claim 13, the method further comprising presenting a plurality of timers, where each timer of the plurality of timers corresponds to a different patient care action.

18. The method of claim 13, the method further comprising generating a prompt includes audio-visual cues.
